(19) United States
(12) Patent Application Publication
(10) Pub. No.: US 2010/0242869 A1
(43) Pub. Date: Sep. 30, 2010

(54) Cylinder head of an internal combustion engine

(75) Inventor: Christof Knollmayr, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL LIST GMBH

(21) Appl. No.: 12/659,852

(22) Filed: Mar. 23, 2010

(30) Foreign Application Priority Data
Mar. 24, 2009 (AT) A 468/2009

(51) Int. Cl. F02F 1/40

(52) U.S. Cl. 123/41.82 R

(57) ABSTRACT

A cylinder head of an internal combustion engine for a vehicle has a plurality of cylinders, with an inlet side and an outlet side with at least one outlet channel for each cylinder, the cylinder head containing a coolant jacket which has a coolant collecting channel extending along the cylinder head on the outlet side above the outlet channels, the coolant collecting channel being connected to outlet-side cooling spaces which at least partially surround the outlet channel and are flow-connected to at least one overflow opening in a cylinder head sealing plane. The coolant collecting channel is directly connected to a heating circuit of the vehicle.

### BACKGROUND OF THE INVENTION

The invention relates to a cylinder head of an internal combustion engine with a plurality of cylinders, with an inlet side and an outlet side with at least one outlet channel for each cylinder, the cylinder head containing a coolant jacket which has a coolant collecting channel extending along the cylinder head on the outlet side above the outlet channels, the coolant collecting channel being connected to outlet-side cooling spaces which at least partially surround the outlet channel and are flow-connected to at least one overflow opening in a cylinder head sealing plane.

A cylinder head for an internal combustion engine that has a coolant jacket is known from JP 2006-083770 A. In this case, a first cooling space is arranged below the outlet channels and a second cooling space is arranged above the outlet channels. The coolant flows from an overflow opening of the cylinder head sealing plane into the first cooling space, flows round the outlet channels at least partially and flows in the region of an engine longitudinal plane containing the cylinder axes upward into the second cooling space and leaves the coolant jacket via a coolant outlet opening. The overflow opening and the coolant outlet are located at different end sides of the cylinder head, so that the coolant jacket is flowed through substantially in the longitudinal direction.

EP 0 244 735 A2 describes a cylinder head for a liquid-cooled series internal combustion engine containing in its cooling jacket a pipeline which protrudes, starting from a coolant outlet opening for connecting a heating device, into the cooling jacket in an exposed manner. The heating device of the vehicle can be directly connected to the cooling jacket of the cylinder head via the pipeline.

DE 32 40 198 A1 discloses a liquid-cooled, temperature-controlled internal combustion engine with a heating return channel which is integrated into the engine and arranged in a cylinder head made of light metal. This is intended to achieve rapid warming of the coolant flowing back out of the heater in the warm-up period of the internal combustion engine.

The object of the invention is to optimally cool thermally critical regions in a cylinder head and to allow rapid heating-up of the vehicle interior.

### SUMMARY OF THE INVENTION

According to the invention, this is achieved in that the coolant collecting channel is directly connected to a heating circuit of the vehicle, the feed pipe of the vehicle heating circuit preferably branching off from the coolant collecting channel.

Particularly rapid heating-up of the heating circuit is achieved if the coolant collecting channel is flow-connected for each cylinder to an outlet-side cooling space at least partially surrounding the outlet channels.

In order to allow sufficient cooling of thermally critical regions on the exterior, provision is made for at least a first overflow opening for flow connection to a coolant jacket of the cylinder block to be arranged on the outlet side for each cylinder.

In an advantageous variant embodiment, provision is made for at least a second overflow opening for flow connection to the coolant jacket of the cylinder block to be arranged on the inlet side for each cylinder. This allows the coolant to flow substantially in the transverse direction between the first and the second overflow openings, each first overflow opening preferably being a pressure source and each second overflow opening preferably being a pressure sink.

Alternatively thereto or additionally, provision may be made for the coolant jacket to have at least one end side of the cylinder head at least one coolant opening, the coolant flowing substantially in the longitudinal direction of the cylinder head between first overflow openings and the coolant opening, each first overflow opening preferably being a pressure source and the coolant opening preferably being a pressure sink.

### BRIEF DESCRIPTION OF THE DRAWINGS

The invention will be described hereinafter with reference to the figures, in which:

FIG. 1 is an oblique view of a coolant jacket of a cylinder head according to the invention;

FIG. 2 shows a cylinder head according to the invention in a section along the line II-II in FIG. 3; and

FIG. 3 shows the cylinder head in a section along the line in FIG. 2.

### DETAILED DESCRIPTION OF THE PREFERRED EMBODIMENT

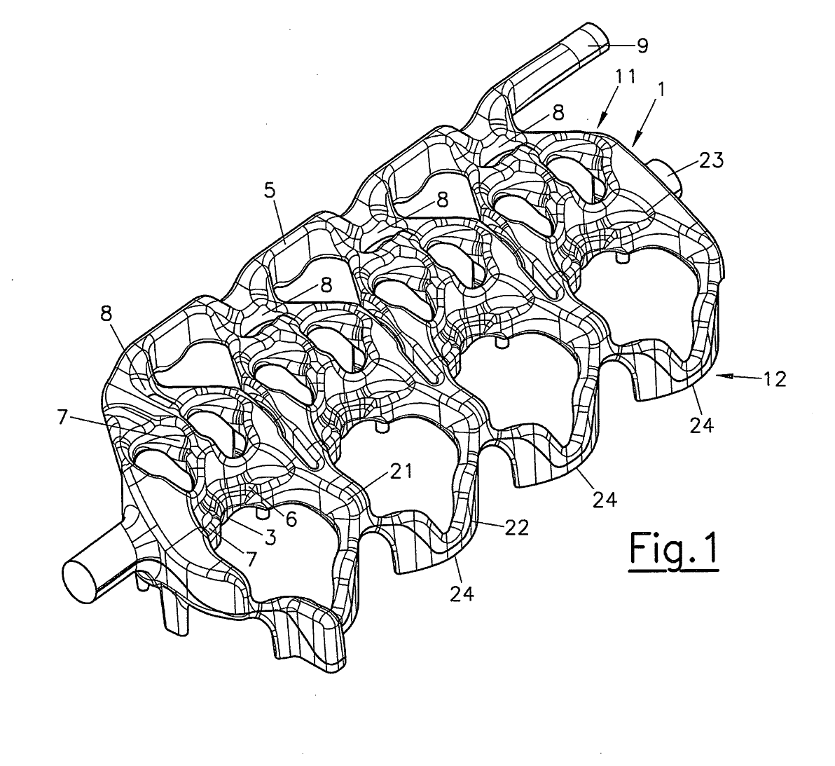

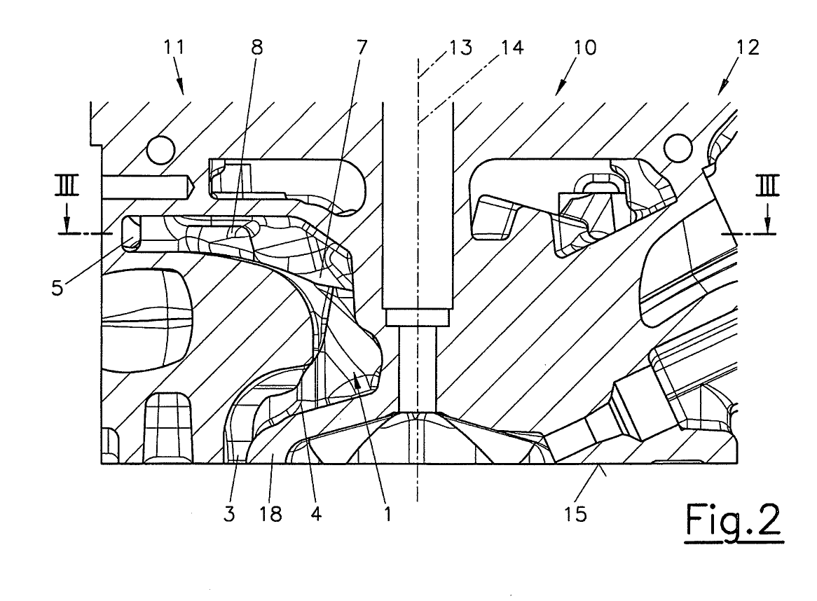

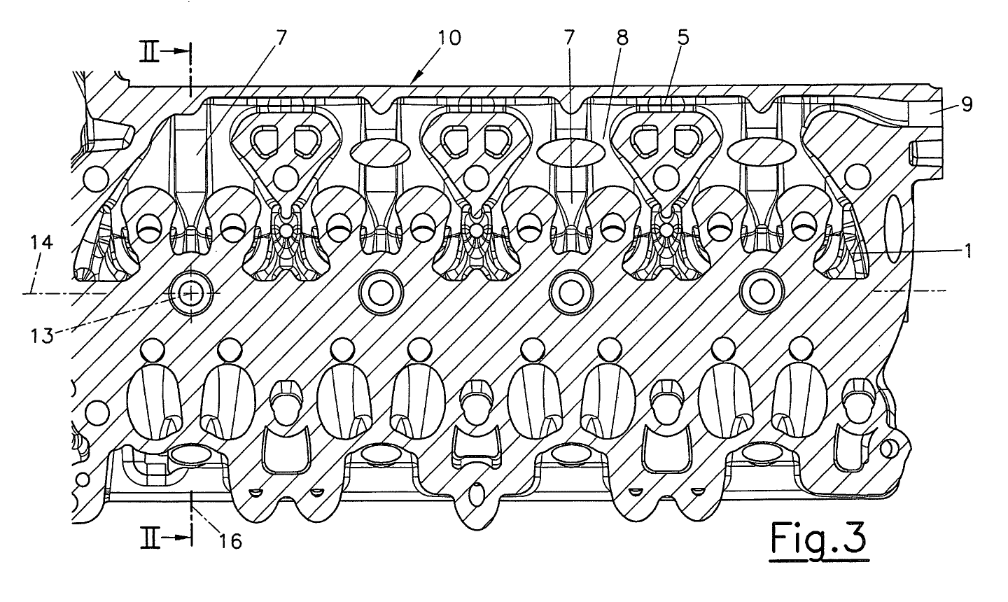

FIG. 2 and FIG. 3 show a cylinder head 10 having a coolant jacket 1 arranged predominantly on the outlet side 11 of the cylinder head 10. The outlet side 11 and inlet side 12 of the cylinder head 10 are located on different sides of an engine longitudinal plane 14 running through the cylinder axes 13. The coolant jacket 1 of the cylinder head 10 is explicitly illustrated in FIG. 1. It has a lateral coolant collecting channel 5 extending in the longitudinal direction of the cylinder head 10 above the outlet channels. For each cylinder, a first overflow opening 3 is arranged in the cylinder head sealing plane 15 of the cylinder head 10 in the region of a respective first engine transverse plane 16 running through the cylinder axis 13 between two respective outlet channels. A first transverse cooling passage 4 arranged in the first transverse engine plane 16 emanates from each first overflow opening 3 in the region of the valve bridge 18 between two outlet ports (not shown in greater detail). Before the engine longitudinal plane 14, the first transverse cooling passage 4 splits into two partial cooling passages 6, 7, each partial cooling passage 6, 7 surrounding the respective outlet channel in the region of the outlet ports at an angle of about 180°.

The coolant jacket 1 can be flowed through transversely or flowed through longitudinally. In the case of transverse flow, second overflow openings are arranged on the inlet side 12 in the region of the first engine transverse planes 16. The position of the second overflow openings is indicated in FIG. 1 by reference numeral 24. The coolant passes from the cylinder block into the coolant jacket 1 via the first overflow openings 3, flows through the outlet-side cooling spaces 7 around the outlet channels and passes via connecting channels 21 between two cylinders onto the inlet side 12 into inlet-side cooling spaces 22 from which the coolant flows back into the coolant jacket of the cylinder block via the second overflow openings 4.

Instead of the second overflow openings 24 or in addition to the second overflow openings 24, the coolant jacket 1 can have in the region of at least one end side of the cylinder head 10 at least one coolant opening 23 through which a longitudinal flow in the coolant jacket 1 can be implemented. The coolant passes into the coolant jacket 1 via the first overflow openings 3 and leaves the coolant jacket again through the coolant opening 23.

For each cylinder, the coolant collecting channel 5 arranged above the outlet channels, that is to say on the side of the outlet channels that is remote from the cylinder head sealing plane 15, on the outlet side 11 is connected to the outlet-side cooling spaces 7 via at least one flow connection 8. At an end side of the cylinder head 10, the coolant collecting channel 5 has a connection 9 for connecting to a heating circuit of a vehicle. The coolant which is warmed up in the coolant jacket 1 of the cylinder head 10 can thus overflow into the heating circuit (not shown in greater detail) of the vehicle directly via the coolant collecting channel 5, thus ensuring rapid heating-up of the vehicle interior.

I claim:

1. Cylinder head of an internal combustion engine for a vehicle with a plurality of cylinders, with an inlet side and an outlet side with at least one outlet channel for each cylinder, the cylinder head containing a coolant jacket which has a coolant collecting channel extending along the cylinder head on the outlet side above the outlet channels, the coolant collecting channel being connected to outlet-side cooling spaces which at least partially surround the outlet channel and are flow-connected to at least one overflow opening in a cylinder head sealing plane, wherein the coolant collecting channel is directly connected to a heating circuit of the vehicle.

2. Cylinder head according to claim 1, wherein a feed pipe of the heating circuit is connected to the coolant collecting channel.

3. Cylinder head according to claim 1, wherein the coolant collecting channel is flow-connected for each cylinder to an outlet-side cooling space at least partially surrounding the outlet channels.

4. Cylinder head according to claim 1, wherein at least a first overflow opening for flow connection to a coolant jacket of the cylinder block is arranged on the outlet side for each cylinder.

5. Cylinder head according to claim 1, wherein at least a second overflow opening for flow connection to the coolant jacket of the cylinder block is arranged on the inlet side for each cylinder.

6. Cylinder head according to claim 5, wherein the coolant flows substantially in a transverse direction between the first and the second overflow openings.

7. Cylinder head according to claim 6, wherein each first overflow opening is a pressure source and each second overflow opening is a pressure sink.

8. Cylinder head according to claim 1, wherein the coolant jacket has at least one end side of the cylinder head at least one coolant opening, the coolant flowing substantially in the longitudinal direction of the cylinder head between first overflow openings and the coolant opening.

9. Cylinder head according to claim 8, wherein each first overflow opening is a pressure source and the coolant opening is a pressure sink.
